(19) United States
(12) Patent Application Publication
(10) Pub. No.: US 2017/0142065 A1
(43) Pub. Date: May 18, 2017

(54) SYSTEM, METHOD, AND RECORDING MEDIUM FOR AN EMOTIONAL FIREWALL FOR DELETERIOUS INFORMATION

(71) Applicant: International Business Machines Corporation, Armonk, NY (US)

(72) Inventors: Minkyong Kim, Scarsdale, NY (US); James Robert Kozloski, New Fairfield, CT (US); Clifford A. Pickover, Yorktown Heights, NY (US); Irina Rish, Rye Brook, NY (US)

(21) Appl. No.: 14/944,708

(22) Filed: Nov. 18, 2015

(51) Int. Cl. H04L 29/06; G06F 19/00

(52) U.S. Cl. CPC H04L 63/02; G06F 19/324

(57) ABSTRACT

A method, system, and non-transitory computer readable medium for an emotional firewall including an information gathering device configure to gather information based on a user request, an emotional implication calculating device configured to calculate an emotional implication of conveying the information to a user, and a control device configured to control the conveying of the information to the user based on the emotional implication and a predetermined setting.

### BACKGROUND

The present invention relates generally to controlling potentially harmful information from a user based on emotional implications, and more particularly, but not by way of limitation, to an emotional firewall based system, method, and recording medium for psychological risk evaluation and controlling the conveyance of potentially harmful information from a user.

Conventional techniques of providing information when a patient has requested a broad genetic test, capable of detecting diseases, do not use caution with respect to the patient's emotional response when suddenly being told of diseases with low probability or other diseases that would destroy your life if the patient “knew” about them. That is, although the evidence is “low” for certain correlations to a disease (i.e., for Alzheimer's, Lou Gehrig's disease, etc), the conventional techniques do not consider the potential risk associated with conveying the results to a very nervous person that could devastate/harm the patient.

Other conventional techniques have considered revealing information conditional upon authentication of a unique code associated with a patient apparatus and a unique code associated with a medical service person apparatus. The patient medical information may be stored in a network server accessible by a medical information provider and conveyed in encrypted form to a medical service person apparatus via a patient apparatus. The medical information may be conveyed to the patient apparatus via a cellular communication and then conveyed to the medical service person's apparatus via a short-range direct wireless connection such as BLUETOOTH or Wi-Fi. Once present on the medical service person's apparatus, the medical information may decrypted and displayed. However, these techniques merely control when to release the information and fail to consider the emotional harm the information can have on a patient.

Thus, there is a technical problem in the conventional information disclosing techniques that the techniques do not consider the patient's emotional response to learning of deleterious information. More specifically, with the ease of accessing any information (as easy as asking a Q&A system, ‘Watson, will I get Parkinson's?”), it is the ease with which this information can be accessed and the general, and growing, relevance of the information all diseases (even those for which there is no known cure) that the conventional techniques fail to consider potentially withholding certain information based on the patient's emotional state and effects that the information can have on the person's wellbeing.

### SUMMARY

In an exemplary embodiment, the present invention can provide an emotional firewall system, including an information gathering device configure to gather information based on a user request, an emotional implication calculating device configured to calculate an emotional implication of conveying the information to a user, and a control device configured to control the conveying of the information to the user based on the emotional implication and a predetermined setting.

Further, in another exemplary embodiment, the present invention can provide a non-transitory computer-readable recording medium recording a program for an emotional firewall, the program causing a computer to perform: gathering information based on a user request, calculating an emotional implication of conveying the information to a user, and controlling the conveying of the information to the user based on the emotional implication and a predetermined setting.

Even further, in another exemplary embodiment, the present invention can provide an emotional firewall method, including gathering information based on a user request, calculating an emotional implication of conveying the information to a user, and controlling the conveying of the information to the user based on the emotional implication and a predetermined setting.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a block diagram illustrating a configuration of an emotional firewall system 100.

FIG. 2 exemplarily shows a high level flow chart for an emotional firewall method.

FIG. 3 depicts a cloud computing node according to an embodiment of the present invention.

FIG. 4 depicts a cloud computing environment according to another embodiment of the present invention.

FIG. 5 depicts abstraction model layers according to an embodiment of the present invention.

### DETAILED DESCRIPTION

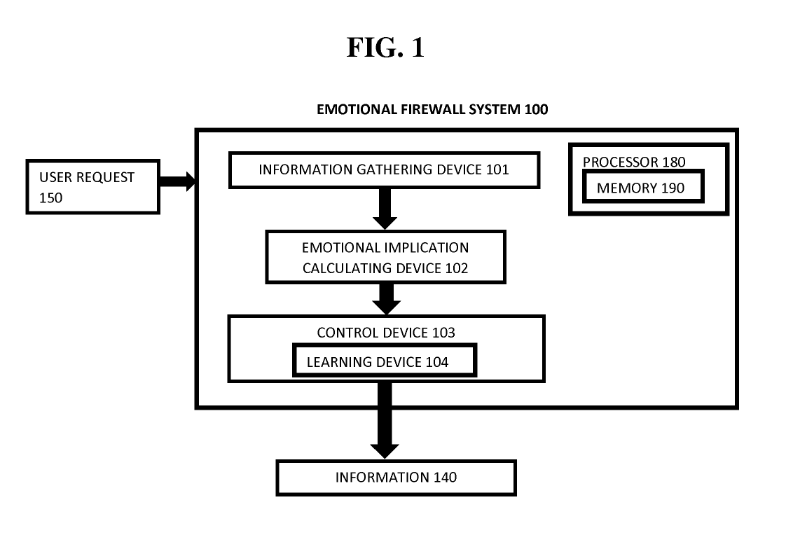

The invention will now be described with reference to FIGS. 1-5, in which like reference numerals refer to like parts throughout. It is emphasized that, according to common practice, the various features of the drawing are not necessary to scale. On the contrary, the dimensions of the various features can be arbitrarily expanded or reduced for clarity. Exemplary embodiments are provided below for illustration purposes and do not limit the claims.

With reference now to FIG. 1, the emotional firewall system 100 includes an information gathering device 101, an emotional implication calculating device 102, and a control device 103. The emotional firewall system 100 receives a user request 150 as an input and provides information 140 as an output (i.e., conveying genetic information to a user).

It should be noted that the user request 150 is not limited to genetic testing information and providing an emotional firewall thereto, and can include but is not limited to, automatic genetic counseling, obsession mitigation when health or safety is threatened (e.g., to help someone who is showing stalking-like behavior), relationship maintenance (e.g., by opting in, a user may be limited in learning about a partner's past relationships through a social networking site), hospice (a user may be limited in learning all the details of their terminal prognosis from a Q &A system), enterprise information hygiene (e.g., to limit an employee's access to salary information of other employees), biomarkers (including a shielding a user if experimental validation is low), endophenotype (a genetic epidemiology term which is used to separate behavioral symptoms into more stable phenotypes with a clear genetic connection), actuarial values (for assessing risk in insurance, finance, lifespan), actuarial models in criminal justice (e.g. predictions of criminality, re-offending, etc.) (partly to avoid self-fulfilling correlations), shielding potential employers from certain candidate information (to avoid later accusations of bias, etc.), shielding people who take certain drugs from one or more side-effects (partly to avoid self-fulfilling expectations of side effects), shielding jurors from certain information related to a case, shielding emotionally vulnerable people (e.g., kids/teenagers in particular) from potentially psychologically damaging online information (e.g., websites related to suicides, certain type of news, etc.), shielding book readers, movie watchers, TV show watchers, etc. from spoilers in plots but (to increase novelty) the nature of the shielding is learned based on user history, cognitive characteristics of cohorts (autism, children, per-Alzheimer's), the wisdom of crowds (suggesting what should not be revealed), or the use of DeepQA technology to infer (with a confidence level) what should be shielded (e.g. when a user asks a question about a movie or book) to a DeepQA agent, etc.

That is, although the embodiments herein are exemplarily directed to genetic tests, it is noted that the invention disclosed herein can be implemented in general “information filtering” types of systems, which also may optionally involve “automated counseling” and the control of deleterious information to a user.

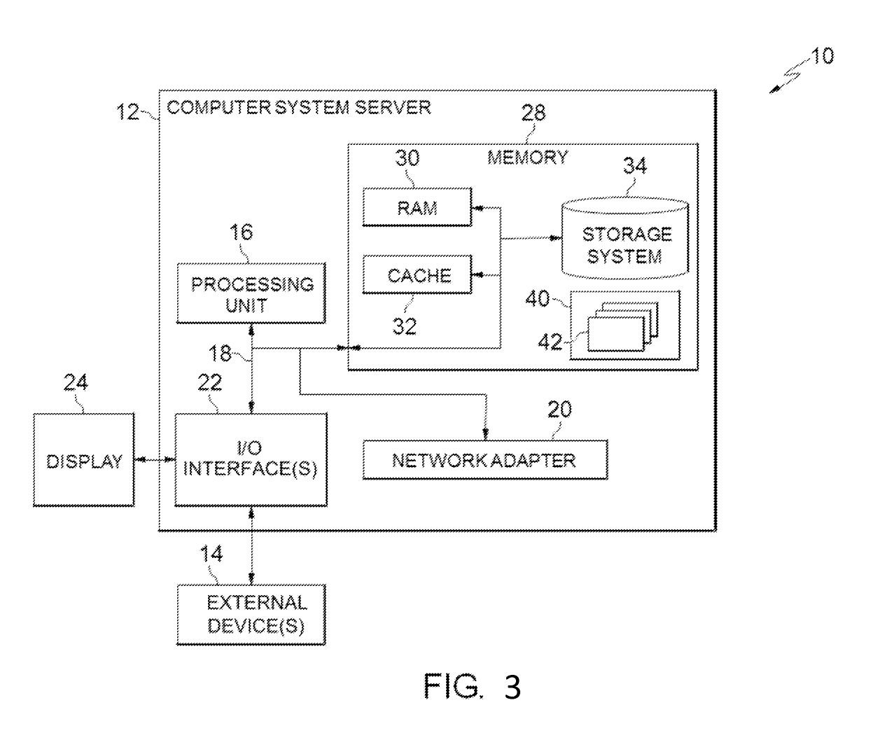

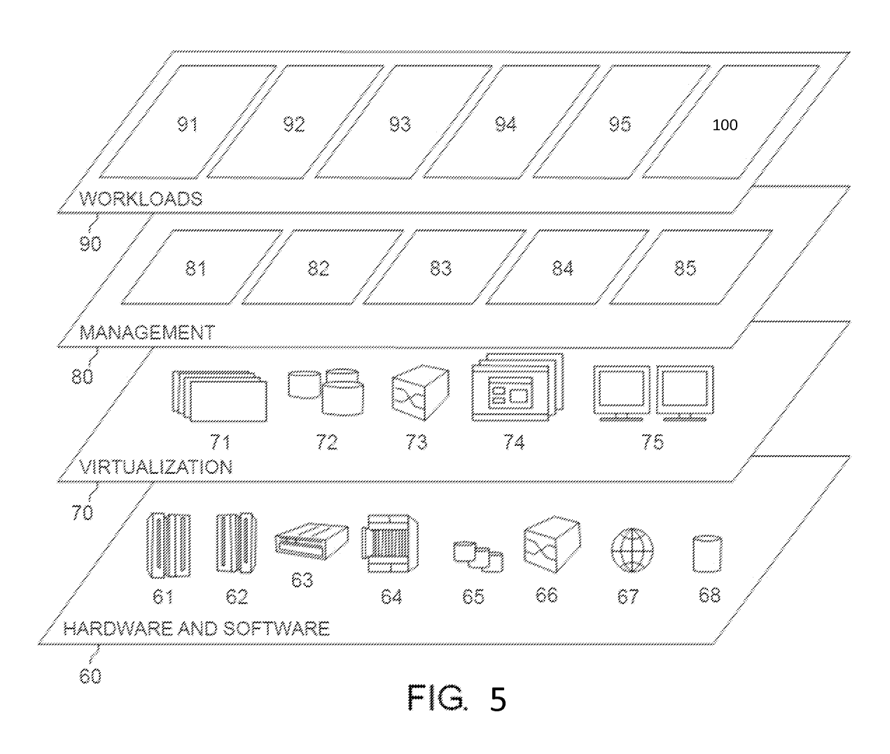

Although as shown in FIGS. 3-5 and as described later, the computer system/server 12 is exemplarily shown in cloud computing node 10 as a general-purpose computing device which may execute in a layer the emotional firewall systems 100 (FIG. 5), it is noted that the present invention can be implemented outside of the cloud environment.

The information gathering device 101 receives the user request 150 and gathers information for the user. The information can include, and is not limited to, genetic information, biomarker information, medical history of families, etc. Based on the gathered information, the information gathering device 101 outputs the diseases associated with the genetics of the patient to the emotional implication calculating device 102.

The emotional implication calculating device 102 receives the information gathered for the user by the information gathering device 101.

The emotional implication calculating device 102 calculates a risk “R” that a user's emotional and psychological health will be affected by the deleterious information when delivered.

Specific state probabilities of the risk to be predicted can include, and are not limited to, anxiety, terror, jealousy, disappointment, depression, suicide, and disgust.

The risk is initially calculated is based on a predetermined list of factors associated with cohorts of patients. However, as described below, the emotional implications are learned, and updated, according to various cohorts of users or on a user specific level such that the emotional implication calculating device 102 learns new factors to improve the calculation of the risk.

In other words, the emotional implication calculating device 102 calculates psychological risks in order to protect the user from information that is (relatively) easily accessible online but can be potentially harmful to the user's psychological/emotional state. That is, the emotional implication calculating device 102 calculates a risk associated with the emotional implication of conveying the information 140 to the user on a user-by-user basis. The emotional implication is output to the control device 103.

The emotional implication can be affected by a real-time biometric indication of the cognitive state of the user based on potentially unstructured information processing in which the emotional implication calculating device 102 takes into account. Various approaches are possible for estimating a user's cognitive state. For example, Face-tracking technology allows computers to read facial expressions and emotions associated therewith.

The control device 103 receives the emotional implication and risk from the emotional implication calculating device 102 of revealing the diseases to the user and controls the information 140 given to the user based on the emotional implication and a firewall with predetermined settings (i.e., a predetermined setting of guidelines on when to convey information to the user). The control device delivers the information 140 to user when R<T, where T is a threshold where the risk is deemed acceptable.

The firewall with predetermined settings includes risks that are pre-programmed into the emotional firewall system as a baseline control for revealing information 140 to the user. For example, the firewall data can consider the risk of suicide increase after learning that one carries the gene for an incurable genetic disease such as Huntington's disease. These risks are evaluated in different contexts such that the system may not completely block information (e.g., carrier status) but delay it until a lower risk context is encountered (e.g., a user having been educated on a topic, or having been evaluated by an automated psychiatric evaluator for stress and depression).

In other words, even if the emotional implication calculated by the emotional implication calculating device 102 is very low, the firewall with predetermined settings of the control device 103 will control the information 140 revealed to the user. In this sense, if there is no emotional implication calculated by the emotional implication calculating device 102, the firewall settings still stop, or at least delay, potentially harmful information 140 from being revealed to the user.

The firewall settings may be changed by the user, family, healthcare professional, social network, etc. Also, the settings may be also affected by a real-time biometric indication of the cognitive state of the user based on potentially unstructured information processing.

Further, the predetermined firewall settings can be determined based on age group, sex, location, etc. That is, the predetermined settings are a baseline control to prevent users from receiving certain data without regard to the emotional implication. The predetermined firewall settings may include, for example, a setting to not disclose to a six year old that they have a gene that results in a terminal disease with absolute certainty when they turn 50 (i.e., no reason to ruin their quality of life at this time).

Based on the emotional implication and the firewall settings, the control device 103 controls the information 140 by any of delaying, counseling, changing the language of, changing the voice used to speak the information; a signal sent to a caregiver, family member, and healthcare professional, etc. Further, the control device 103 can control the manner in which the information is conveyed to the user. For example, instead of merely listing the diseases, the control device 103 can list the facilities working on cures for the diseases so as to improve the users outlook on having the diseases (i.e., although the disease has a death time line of 5 years, the cure may be found by research facility X before then).

The control device 103 can filtering information about one or more drug side effects (partly to avoid self-fulfilling expectations of side effects), for example, until a healthcare professional can better explain the likelihood or severity of having such side-effects for the person or cohort.

If the emotional implication calculating device 102 calculates that the user is in a very stressful state and any sensitive information revealed to the user may put the user in risk of taking action against themselves, the control device 103 can delay the revealing of the information 140 until the user is in a different emotional state where the user can handle the information 140.

In other words, a user may receive information 140 about increased chances of developing a particular disease in the future, which raises a question of whether this type of information is always beneficial to a person; in such cases, the control device 103 evaluates the firewall settings (for example, severity of a disease, the confidence of the prediction (e.g., false positive/false negative rates)) and emotional implication calculated by the emotional implication calculating device 102 (i.e., the severity of psychological burden imposed by sharing such information with a person (e.g., increased chances of anxiety, depression, or even suicide, as it was reported in cases of certain severe genetic diseases, e.g., incurable neurodegenerative disorders such as Huntington disease)).

After evaluating the above factors, the control device 103 can proceed with appropriate ‘counseling’ steps, which may involve an ‘automated’ initial counseling performed by a system, redirection to a human counselor, both, or giving the information 140 to the user if the control device 103 determines that the information 140 is not above the firewall settings and the emotional implication is low. That is, the control device 103 prevents unrestricted sharing of ‘sensitive’ types of information with the user, without any considerations of potential consequences of such information sharing.

The control device 103 includes a learning device 104 to update the predetermined firewall settings of the control device 103.

For example, if the control device 103 determines a delay is necessary for revealing the information and associates the delay with time T for counseling/delaying information delivery. The control device 103 will engage the user for as long a period P, up until P=T, as possible. The learning device 104 receives feedback from user about the usefulness of the delay, and counseling, and adjusts counseling content and schedule accordingly to update the firewall settings.

Also, the learning device 104 learns the emotional implications (with a confidence level L) according to various cohorts of users and updated the firewall settings according to the learned data.

Further, the learning device 104 learns the past actions (such as how the information was filtered and was delivered to the target person along with family members). The learned data gets populated with the successful actions (i.e., firewall setting and information control mechanisms for the control device 103) along with types/characteristics of the information (e.g., genome sequence, deadly diseases) and user profiles (which may include age, sex, disease, etc.) For a given user request 150, the control device 103 searches the knowledge base and recommends the actions based on the updated knowledge base by the learning device 104.

The control device 103 can further control the release of information 140 based upon authentication of a unique code associated with a patient or patient apparatus and a unique code associated with a medical service person or service apparatus. The unique code may be given to medical professionals. The patient medical information may be stored in a network server accessible by a medical information provider and conveyed in encrypted form to a patient or medical service person apparatus via a patient apparatus. The medical information may be conveyed to the patient apparatus via a cellular communication and then conveyed to the medical service person's apparatus via a short-range direct wireless connection such as Bluetooth or Wi-Fi. Once present on the medical service person's apparatus or user's apparatus, the medical information may decrypted and displayed.

The emotional firewall system 100 can be a network compatible and a configurable user interface system for displaying a set of user-selectable, sequentially generated patient medical parameters, together with an associated time indication that comprises a display menu generator for generating a customization menu that enables user selection of a default set of medical parameters from a plurality of available sets of default medical parameters. The customization menu further enables user modification of the default set of medical parameters. A display generator responsive to a user command can operate to display the modified default set of medical parameters in a graphical or tabular format.

Further, the emotional firewall system 100 can be on a network server which can establish sessions to enable a caretaker to engage in a virtual medical consultation with one of a plurality of clinical assessment team members, each using their own respective end-user devices. The network server could send out a notification to one or more clinical assessment team members, and establishes a virtual medical consultation session between the caretaker and the first clinical assessment team member to respond. Subsequent clinical assessment team members who respond are rejected by the network server. Team members other than the first to respond are sent an update to stand down from the notification, thereby indicating that participation in the virtual medical consultation is no longer needed. The end-user devices delete the protected health information exchanged during the session, and generate an alert if copying is detected.

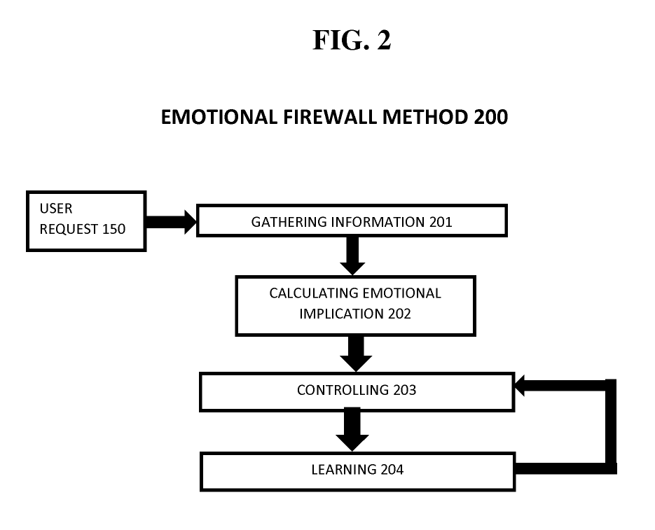

FIG. 2 shows a high level flow chart for a method 200 for an emotional firewall.

Step 201 gathers information based on a user request 150.

Step 202 calculates an emotional implication of revealing the information 140 to the user.

Step 203 controls the output of the information 140 to the user based on the calculated emotional implication and a firewall setting.

Step 204 learns when Step 203 outputs information 140 and does not output information 140 and continuously updates the controlling Step 203 to update the firewall setting.

In view of the foregoing and other problems, disadvantages, and drawbacks of the aforementioned background art, the disclosed invention above can provide a new and improved emotional firewall system which can calculate psychological risk evaluation (i.e., emotional implication) and control the release of information to partially block potentially harmful information from a user.

An exemplary aspect of the disclosed invention provides a system, method, and non-transitory recording medium for emotional firewall which can provide a technical solution to the technical problem in the conventional approaches controlling the information revealed to the user based on the emotional implications and a firewall setting. That is, the disclosed system, method, and non-transitory recording medium for emotional firewall factors in the harm associated with revealing sensitive information so as to potentially block the information from being revealed unless it is necessary to reveal.

In this manner, the disclosed invention can provide a technical solution to the technical problem in the conventional approaches and each word can be given a definition in the sequence to determine and discern the items with multiple meanings. Further, the new and improved emotional firewall system is based on vectors such that no auxiliary structures such as dictionaries are needed and the senses are not defined in advance and are actually discovered and characterized by listing the words having them.

Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

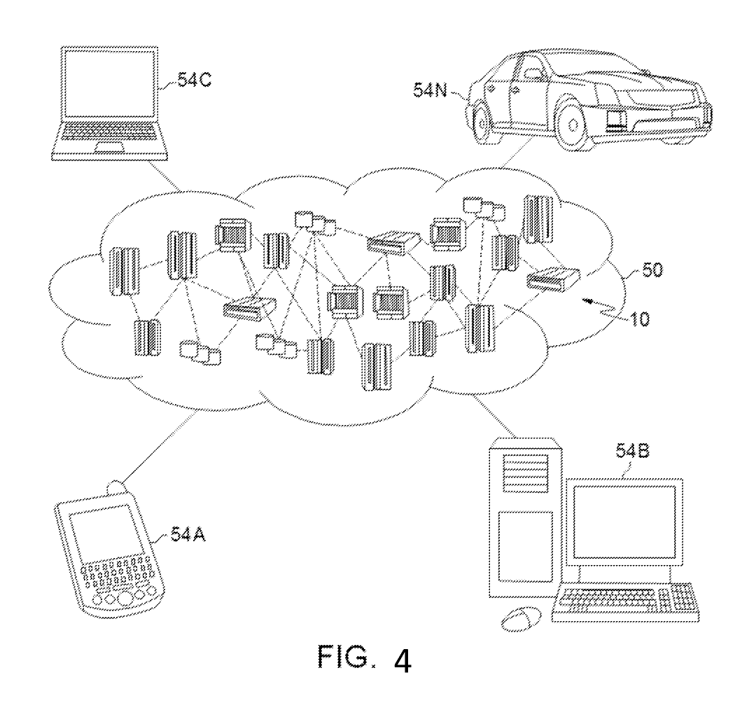

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the emotional firewall system 100 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. An emotional firewall system, comprising:
an information gathering device configured to gather information based on a user request;
an emotional implication calculating device configured to calculate an emotional implication of conveying the information to a user; and
a control device configured to control the conveying of the information to the user based on the emotional implication and a predetermined setting.

2. The system of claim 1, wherein the information comprises at least one of genetic information, biomarker information, and family medical history information.

3. The system of claim 1, wherein the control device includes a learning device configured to change the control of the control device based on a plurality of calculated emotional implications.

4. The system of claim 1, wherein the control device includes a learning device configured to change the control of the control device based on a plurality of cohorts of users.

5. The system of claim 1, wherein the control device includes a learning device configured to change the control of the control device based on a reaction of the user when the control device conveys the information to the user.

6. The system of claim 1, wherein the predetermined setting is set by at least one of a user, a family member, a healthcare professional, and social network data.

7. The system of claim 1, wherein the control device delays the conveying of the information to the user based on a risk associated with the calculated emotional implication.

8. The system of claim 1, wherein the control device controls the conveying of the information to the user by at least one of changing a tone of the information, changing vocabulary used in delivering the information, and changing a wording of the information, changing a voice associated with conveying the information, delaying the conveying of the information until a healthcare provider is with the user, and delaying the conveying of the information until a family member is with the user based on a risk associated with the calculated emotional implication.

9. The system of claim 1, wherein the emotional implication calculating device calculates a risk associated with the emotional implication of conveying the information to the user on a user-by-user basis.

10. The system of claim 1, wherein the control device includes a learning device configured to change the control of the control device based on a risk factor input by a healthcare professional.

11. The system of claim 1, wherein the emotional implication calculating device calculates the emotional implication of conveying the information to the user based on a real-time biometric indication of a cognitive state of the user.

12. The system of claim 1, wherein the emotional implication calculating device calculates the emotional implication of conveying the information to the user based on a real-time biometric indication of a cognitive state of the user associated with conveying of unstructured information processing by the user.

13. The system of claim 1, wherein the control device includes a learning device configured to update the predetermined setting based on a prior conveying of information to the user.

14. The system of claim 1, wherein the control device is further configured to filter information about one or more drug side effects.

15. A non-transitory computer-readable recording medium recording a program for an emotional firewall, the program causing a computer to perform:
gathering information based on a user request;
calculating an emotional implication of conveying the information to a user; and
controlling the conveying of the information to the user based on the emotional implication and a predetermined setting.

16. The non-transitory computer-readable recording medium of claim 15, wherein the information comprises at least one of genetic information, biomarker information, and family medical history information.

17. The non-transitory computer-readable recording medium of claim 15, further comprising learning, based on a plurality of calculated emotional implications, to change the control of the controlling.

18. An emotional firewall method, comprising:
gathering information based on a user request;
calculating an emotional implication of conveying the information to a user; and
controlling the conveying of the information to the user based on the emotional implication and a predetermined setting.

19. The method of claim 18, wherein the information comprises at least one of genetic information, biomarker information, and family medical history information.

20. The method of claim 18, further comprising learning, based on a plurality of calculated emotional implications, to change the control of the controlling.
